(19) United States
(12) Patent Application Publication
(10) Pub. No.: US 2021/0209470 A1
(43) Pub. Date: Jul. 8, 2021

(54) NETWORK QUANTIZATION METHOD, AND INFERENCE METHOD

(71) Applicant: SOCIONEXT INC., Kanagawa (JP)

(72) Inventor: Yukihiro SASAGAWA, Yokohama (JP)

(21) Appl. No.: 17/210,097

(22) Filed: Mar. 23, 2021

Related U.S. Application Data
(63) Continuation of application No. PCT/JP2018/036104, filed on Sep. 27, 2018.

(51) Int. Cl. G06N 3/08; G06K 9/62

(52) U.S. Cl. CPC G06N 3/08; G06K 9/628; G06K 9/6277; G06K 9/6228

(57) ABSTRACT

A network quantization method of quantizing a neural network includes: constructing a statistical information database of tensors handled by the neural network obtained when a plurality of test datasets are input to the neural network; generating a quantization parameter set by quantizing values of the tensors; and quantizing the neural network using the quantization parameter set. In the generating, based on the statistical information database, a quantization step interval in a high-frequency region is set to be narrower than a quantization step interval in a low-frequency region, the high-frequency region including a value, among the values of the tensors, having a frequency that is a maximum, and the low-frequency region including a value of the tensors that has a lower frequency than in the high-frequency region and a frequency that is not zero.

### CROSS REFERENCE TO RELATED APPLICATION

This is a continuation application of PCT Patent Application No. PCT/JP2018/036104 filed on Sep. 27, 2018, designating the United States of America. The entire disclosure of the above-identified application, including the specification, drawings and claims is incorporated herein by reference in its entirety.

### FIELD

The present disclosure relates to a network quantization method, and an inference method.

### BACKGROUND

Thus far, machine learning has been performed using networks such as neural networks. Here, the “network” is a model that takes numerical data as an input and applies some kind of operation to obtain an output value of the numerical data. When implementing a network using hardware such as a computer, to keep hardware costs low, it is necessary to construct the network with a lower operational precision while keeping the post-implementation inference precision at approximately the same level as the floating point precision.

For example, implementing a network in which all calculations are performed with floating point precision increases the hardware costs, and it is therefore necessary to implement a network that performs calculations at fixed point precision while maintaining the inference precision.

In the following, a floating point-precision network will also be referred to as a “pre-quantization network”, and a fixed point-precision network will also be referred to as a “quantized network”.

Here, the process of encoding floating point values, which can express almost any value continuously, by dividing the floating point values into predetermined segments is referred to as “quantization”. More generally, quantization is defined as a process of reducing the number of digits or range of numerical values handled by a network.

When expressing a real number with a limited number of bits through quantization, the distribution of the input data may differ from an assumed distribution. In this case, quantization error increases, which has a negative impact on the speed of the machine learning as well as on the precision of the inference after learning.

The method described in PTL 1, for example, is known as a method for solving such a problem. According to the method described in PTL 1, a separate fixed-point format is defined for each of weights and data in each layer of a convolutional neural network. Machine learning of convolutional neural networks is started with floating point numbers, and analysis is then performed to estimate the distribution of the input data. An optimal number format for the input data values is then determined based on the distribution of the input data, and quantization is performed using that format. As such, PTL 1 attempts to solve the stated problem by first examining the distribution of the input data and then selecting a number format suited to that distribution.

### CITATION LIST

### Patent Literature

PTL 1: Japanese Unexamined Patent Application Publication No. 2018-10618

### SUMMARY

### Technical Problem

According to the method described in PTL 1, the dynamic range of the data handled is taken into account, and a limited number of bits are assigned to a range into which that data fits. Here, if the data is distributed unevenly within the stated range, a number of bits will be assigned even to data in sections where there is almost no data at all. This means that the amount of meaningful data is low relative to the number of bits. This in turn reduces the accuracy of the quantization.

Accordingly, having been achieved in order to solve such a problem, an object of the present disclosure is to provide a network quantization method and the like which can construct a quantized network having good accuracy.

### Solution to Problem

To achieve the above-described object, a network quantization method according to one aspect of the present disclosure is a network quantization method of quantizing a neural network. The method includes: preparing the neural network; constructing a statistical information database of tensors handled by the neural network, the tensors obtained when a plurality of test datasets are input to the neural network; generating a quantization parameter set by quantizing values of the tensors based on the statistical information database and the neural network; and constructing a quantized network by quantizing the neural network using the quantization parameter set. In the generating, based on the statistical information database, a quantization step interval in a high-frequency region is set to be narrower than a quantization step interval in a low-frequency region, the high-frequency region including a value, among the values of the tensors, having a frequency that is a local maximum, and the low-frequency region including a value of the tensors that has a lower frequency than in the high-frequency region and a frequency that is not zero.

To achieve the above-described object, a network quantization method according to one aspect of the present disclosure is a network quantization method of quantizing a neural network. The method includes: preparing the neural network; constructing a statistical information database of tensors handled by the neural network, the tensors obtained when a plurality of test datasets are input to the neural network; generating a quantization parameter set by quantizing values of the tensors based on the statistical information database and the neural network; and constructing a quantized network by quantizing the neural network using the quantization parameter set. In the generating, based on the statistical information database, of the values of the tensors, a quantization region for values of tensors which do not have a frequency of zero and a non-quantization region for values of tensors which do not have a frequency of zero and which does not overlap with the quantization region are determined, the values of the tensors in the quantization region are quantized, and the values of the tensors in the non-quantization region are not quantized.

To achieve the above-described object, a network quantization method according to one aspect of the present disclosure is a network quantization method of quantizing a neural network. The method includes: preparing the neural network; constructing a statistical information database of tensors handled by the neural network, the tensors obtained when a plurality of test datasets are input to the neural network; generating a quantization parameter set by quantizing values of the tensors based on the statistical information database and the neural network; and constructing a quantized network by quantizing the neural network using the quantization parameter set. In the generating, the values of the tensors are quantized to three values of −1, 0, and +1 based on the statistical information database.

To achieve the above-described object, a network quantization method according to one aspect of the present disclosure is a network quantization method of quantizing a neural network. The method includes: preparing the neural network; constructing a statistical information database of tensors handled by the neural network, the tensors obtained when a plurality of test datasets are input to the neural network; generating a quantization parameter set by quantizing values of the tensors based on the statistical information database and the neural network; and constructing a quantized network by quantizing the neural network using the quantization parameter set. In the generating, the values of the tensors are quantized to two values of −1 and +1 based on the statistical information database.

To achieve the above-described object, an inference method according to one aspect of the present disclosure includes the above-described network quantization method, the network quantization method further including classifying at least some of the plurality of test datasets into a first type and a second type based on respective instances of statistical information in the plurality of test datasets. The statistical information database includes a first database subset and a second database subset corresponding to the first type and the second type, respectively. The quantization parameter set includes a first parameter subset and a second parameter subset corresponding to the first database subset and the second database subset, respectively. The quantized network includes a first network subset and a second network subset constructed by quantizing the neural network using the first parameter subset and the second parameter subset, respectively. The inference method includes selecting, from the first type and the second type, a type into which input data input to the quantized network is to be classified; selecting one of the first network subset and the second network subset based on the type, of the first type and the second type, selected in the selecting of the type; and inputting the input data into the one of the first network subset and the second network subset selected in the selecting of the one of the first network subset and the second network subset.

To achieve the above-described object, a network quantization apparatus according to one aspect of the present disclosure is a network quantization apparatus that quantizes a neural network. The apparatus includes: a database constructor that constructs a statistical information database of tensors handled by the neural network, the tensors obtained when a plurality of test datasets are input to the neural network; a parameter generator that generates a quantization parameter set by quantizing values of the tensors based on the statistical information database and the neural network; and a network constructor that constructs a quantized network by quantizing the neural network using the quantization parameter set. Based on the statistical information database, the parameter generator sets a quantization step interval in a high-frequency region to be narrower than a quantization step interval in a low-frequency region, the high-frequency region including a value, among the values of the tensors, having a frequency that is a local maximum, and the low-frequency region including a value of the tensors that has a lower frequency than in the high-frequency region and a frequency that is not zero.

To achieve the above-described object, a network quantization apparatus according to one aspect of the present disclosure is a network quantization apparatus that quantizes a neural network. The apparatus includes: a database constructor that constructs a statistical information database of tensors handled by the neural network, the tensors obtained when a plurality of test datasets are input to the neural network; a parameter generator that generates a quantization parameter set by quantizing values of the tensors based on the statistical information database and the neural network; and a network constructor that constructs a quantized network by quantizing the neural network using the quantization parameter set. Based on the statistical information database, of the values of the tensors, the parameter generator determines a quantization region for values of tensors which do not have a frequency of zero and a non-quantization region for values of tensors which do not have a frequency of zero and which does not overlap with the quantization region, quantizes the values of the tensors in the quantization region, and does not quantize the values of the tensors in the non-quantization region.

To achieve the above-described object, a network quantization apparatus according to one aspect of the present disclosure is a network quantization apparatus that quantizes a neural network. The apparatus includes: a database constructor that constructs a statistical information database of tensors handled by the neural network, the tensors obtained when a plurality of test datasets are input to the neural network; a parameter generator that generates a quantization parameter set by quantizing values of the tensors based on the statistical information database and the neural network; and a network constructor that constructs a quantized network by quantizing the neural network using the quantization parameter set. The parameter generator quantizes the values of the tensors to three values of −1, 0, and +1 based on the statistical information database.

To achieve the above-described object, a network quantization apparatus according to one aspect of the present disclosure is a network quantization apparatus that quantizes a neural network. The apparatus includes: a database constructor that constructs a statistical information database of tensors handled by the neural network, the tensors obtained when a plurality of test datasets are input to the neural network; a parameter generator that generates a quantization parameter set by quantizing values of the tensors based on the statistical information database and the neural network; and a network constructor that constructs a quantized network by quantizing the neural network using the quantization parameter set. The parameter generator quantizes the values of the tensors to two values of −1 and +1 based on the statistical information database.

### Advantageous Effects

According to the present disclosure, a network quantization method and the like that can construct a quantized network having good accuracy can be provided.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram illustrating an overview of the functional configuration of a network quantization apparatus according to Embodiment 1.

FIG. 2 is a diagram illustrating an example of the hardware configuration of a computer that uses software to implement functions of the network quantization apparatus according to Embodiment 1.

FIG. 3 is a flowchart illustrating a network quantization method according to Embodiment 1.

FIG. 4 is a schematic diagram illustrating a quantization method according to a comparative example.

FIG. 5 is a schematic diagram illustrating a quantization method according to Embodiment 1.

FIG. 6 is a schematic diagram illustrating a quantization range according to a variation on Embodiment 1.

FIG. 7 is a schematic diagram illustrating an example of a quantization step interval determination method according to a variation on Embodiment 1.

FIG. 8 is a schematic diagram illustrating another example of a quantization step interval determination method according to a variation on Embodiment 1.

FIG. 9 is a block diagram illustrating an overview of the functional configuration of a network quantization apparatus according to Embodiment 2.

FIG. 10 is a flowchart illustrating a network quantization method and an inference method according to Embodiment 2.

### DESCRIPTION OF EMBODIMENTS

Exemplary embodiments of the present disclosure will be described in detail hereinafter with reference to the drawings. Note that the following embodiments describe specific examples of the present disclosure. The numerical values, shapes, materials, standards, constituent elements, arrangements and connection states of constituent elements, steps, orders of steps, and the like in the following embodiments are merely examples, and are not intended to limit the present disclosure. Additionally, of the constituent elements in the following embodiments, constituent elements not denoted in the independent claims, which express the broadest interpretation of the present disclosure, will be described as optional constituent elements. Additionally, the drawings are not necessarily exact illustrations. Configurations that are substantially the same are given the same reference signs in the drawings, and redundant descriptions may be omitted or simplified.

### Embodiment 1

A network quantization method and a network quantization apparatus according to Embodiment 1 will be described.

### 1-1. Network Quantization Apparatus

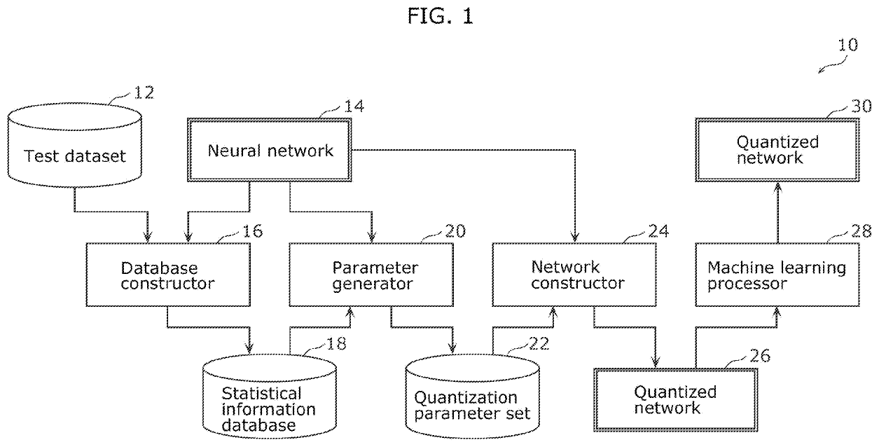

The configuration of the network quantization apparatus according to the present embodiment will be described first with reference to FIG. 1. FIG. 1 is a block diagram illustrating an overview of the functional configuration of network quantization apparatus 10 according to the present embodiment.

Network quantization apparatus 10 is an apparatus that quantizes neural network 14. In other words, network quantization apparatus 10 is an apparatus that converts floating point-precision neural network 14 to a fixed point-precision neural network. Note that network quantization apparatus 10 need not quantize all tensors handled by neural network 14, and it is acceptable for network quantization apparatus 10 to quantize at least some of the tensors. Here, a “tensor” is a value represented by an n-dimensional array (where n is an integer of 0 or higher) containing parameters such as input data, output data, and weights in each layer of neural network 14. The tensor may include parameters pertaining to the smallest unit of operations in neural network 14. When neural network 14 is a convolutional neural network, the weights and bias values, which are functions defined as convolutional layers, may be included in the tensor. Additionally, parameters such as normalization processing in neural network 14 may be included in the tensor.

As illustrated in FIG. 1, network quantization apparatus 10 includes database constructor 16, parameter generator 20, and network constructor 24. In the present embodiment, network quantization apparatus 10 further includes machine learning processor 28.

Database constructor 16 is a processor that constructs statistical information database 18 of the tensors handled by neural network 14 obtained when a plurality of test datasets 12 are input to neural network 14. Database constructor 16 calculates statistical information such as a relationship between the value and frequency of each tensor handled by neural network 14 for the plurality of test datasets 12, and constructs statistical information database 18 for each tensor. At least some of statistical amounts, such as the mean value, median value, mode value, global maximum value, global minimum value, local maximum value, local minimum value, variance, deviation, skewness, and kurtosis for each tensor, are included in statistical information database 18.

Parameter generator 20 is a processor that generates a quantization parameter set by quantizing the tensor values based on statistical information database 18 and neural network 14. Based on statistical information database 18, parameter generator 20 sets a quantization step interval in a high-frequency region which includes the tensor values having a local maximum frequency to be narrower than a quantization step interval in a low-frequency region which includes tensor values having a lower frequency than those in the high frequency region and having a non-zero frequency. The processing performed by parameter generator 20 will be described in detail later.

Network constructor 24 is a processor that constructs quantized network 26 by quantizing neural network 14 using quantization parameter set 22.

Machine learning processor 28 is a processor that causes quantized network 26 to perform machine learning. Machine learning processor 28 causes the machine learning to be performed by inputting the plurality of test datasets 12 or other input datasets into quantized network 26 constructed by network constructor 24. Through this, machine learning processor 28 constructs quantized network 30, which has a better inference accuracy than quantized network 26. Note that network quantization apparatus 10 does not absolutely have to include machine learning processor 28.

Through the configuration described above, network quantization apparatus 10 can construct a quantized network having good accuracy.

### 1-2. Hardware Configuration

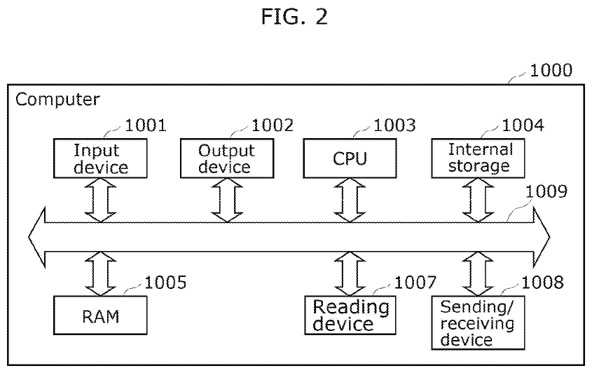

The hardware configuration of network quantization apparatus 10 according to the present embodiment will be described next with reference to FIG. 2. FIG. 2 is a diagram illustrating an example of the hardware configuration of computer 1000 that uses software to implement functions of network quantization apparatus 10 according to the present embodiment.

As illustrated in FIG. 2, computer 1000 is a computer that includes input device 1001, output device 1002, CPU 1003, internal storage 1004, RAM 1005, reading device 1007, sending/receiving device 1008, and bus 1009. Input device 1001, output device 1002, CPU 1003, internal storage 1004, RAM 1005, reading device 1007, and sending/receiving device 1008 are connected by bus 1009.

Input device 1001 is a device serving as a user interface, such as an input button, a touch pad, a touch panel display, or the like, and accepts user operations. Note that in addition to accepting tactile operations from the user, input device 1001 may also be configured to accept voice operations and remote operations using a remote control or the like.

Internal storage 1004 is flash memory or the like. At least one of a program for realizing a function of network quantization apparatus 10 and an application that uses the functional configuration of network quantization apparatus 10 may be stored in internal storage 1004 in advance.

RAM 1005 is random access memory and is used to store data and the like when executing programs or applications.

Reading device 1007 reads information from a recording medium such as Universal Serial Bus (USB) memory. Reading device 1007 reads programs or applications such as those mentioned above from the recording medium in which those programs and applications are recorded and causes the programs and applications to be stored in internal storage 1004.

Sending/receiving device 1008 is a communication circuit for performing wireless or wired communication. Sending/receiving device 1008 communicates with, for example, a server device connected to a network, downloads programs and applications such as those mentioned above from the server device, and causes the programs and applications to be stored in internal storage 1004.

CPU 1003 is a central processing unit that copies the programs and applications stored in internal storage 1004 into RAM 1005, sequentially reads out commands included in those programs and applications from RAM 1005, and executes the commands.

### 1-3. Network Quantization Method

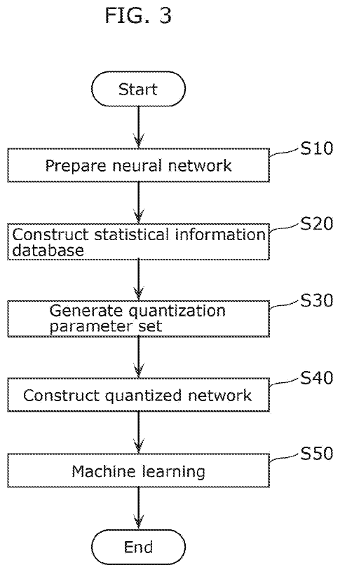

A network quantization method according to the present embodiment will be described next with reference to FIG. 3. FIG. 3 is a flowchart illustrating the network quantization method according to the present embodiment.

As illustrated in FIG. 3, in the network quantization method, first, neural network 14 is prepared (S10). In the present embodiment, a pre-trained neural network 14 is prepared. Neural network 14 is not quantized, i.e., is a floating point-precision neural network. Note that the input data used to train neural network 14 is not particularly limited, and may include the plurality of test datasets 12 illustrated in FIG. 1.

Next, database constructor 16 constructs a statistical information database of the tensors handled by neural network 14 obtained when a plurality of test datasets 12 are input to neural network 14 (S20). In the present embodiment, database constructor 16 calculates statistical information such as a relationship between the value and frequency of each tensor handled by neural network 14 for the plurality of test datasets 12, and constructs statistical information database 18 for each tensor.

Next, parameter generator 20 generates quantization parameter set 22 by quantizing the tensor values based on statistical information database 18 and neural network 14 (S30).

Next, network constructor 24 constructs quantized network 26 by quantizing neural network 14 using quantization parameter set 22 (S40).

Next, machine learning processor 28 causes quantized network 26 to perform machine learning (S50). Machine learning processor 28 causes the machine learning to be performed by inputting the plurality of test datasets 12 or other input datasets into quantized network 26 constructed by network constructor 24. Through this, quantized network 30, which has a better inference accuracy than quantized network 26, can be constructed. Note that the network quantization method according to the present embodiment does not absolutely have to include machine learning step S50.

As described above, with the network quantization method according to the present embodiment, a neural network can be quantized accurately.

### 1-4. Parameter Generator

A method by which parameter generator 20 according to the present embodiment generates quantization parameter set 22 will be described in detail next.

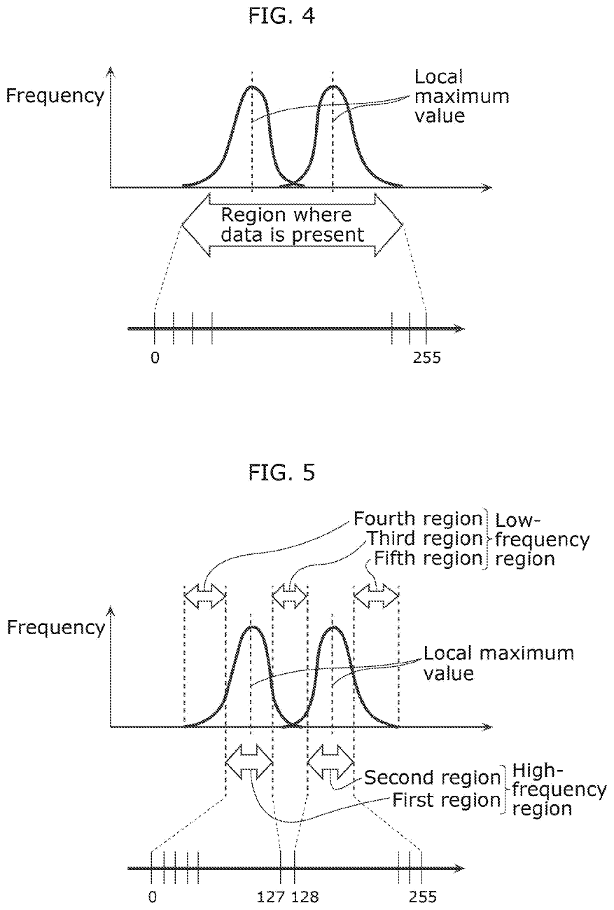

As described above, parameter generator 20 generates a quantization parameter set by quantizing the tensor values based on statistical information database 18 and neural network 14. A quantization method used by parameter generator 20 will be described below with reference to FIGS. 4 and 5, while comparing the method to a quantization method according to a comparative example. FIGS. 4 and 5 are schematic diagrams illustrating the quantization methods according to the comparative example and the present embodiment, respectively. FIGS. 4 and 5 illustrate graphs indicating a relationship between the value and frequency of each tensor handled by neural network 14.

In the example distribution of tensor values illustrated in FIG. 4, the frequency has two local maximum values, and the frequency is low in a region between the two local maximum values and in regions outside the two local maximum values. When the tensor values are unevenly distributed in this manner, with, for example, the comparative example, which uses a quantization method according to the related art described in PTL 1, the entire region where data is present is quantized in a uniform manner. As one example, FIG. 4 illustrates an example of quantization at a resolution of 8 bits.

With the quantization method according to the comparative example, because regions where data is present but has a low frequency are also quantized, a number of bits are assigned even to data in sections where there is almost no data. This means that the amount of meaningful data is low relative to the number of bits. This in turn reduces the accuracy of the quantization.

However, based on statistical information database 18, parameter generator 20 according to the present embodiment sets a quantization step interval in a high-frequency region which includes the tensor values having a local maximum frequency to be narrower than a quantization step interval in a low-frequency region which includes tensor values having a lower frequency than those in the high frequency region and having a non-zero frequency. Through this, the number of bits assigned to a low-frequency region during quantization can be reduced more than in the comparative example described above. This makes it possible to improve the accuracy of the quantization, which in turn makes it possible to construct a quantized network having good accuracy. In the example illustrated in FIG. 5, the high-frequency region includes a first region and a second region, each of which contains the values of the tensors having the locally-maximum frequencies, and the low-frequency region includes a third region, which contains the values of the tensors between the first region and the second region. The tensor values in at least part of the low-frequency region need not be quantized. In the example illustrated in FIG. 5, the low-frequency region is constituted by a fourth region and a fifth region, which contain values outside the first region and the second region, as well as the third region, and the tensor values in the low-frequency region are not quantized. The first region and the second region constituting the high-frequency region are each quantized uniformly at a resolution of 7 bits. Through this, the number of bits assigned to the low-frequency region during quantization can be reduced to a minimum. This makes it possible to even further improve the accuracy of the quantization.

Although the method for determining the high-frequency region and the low-frequency region is not particularly limited, for example, a region constituted by the data in the top 90% in order of frequency may be used as the high-frequency region.

Additionally, although the tensor values in the low-frequency region are not quantized in the example illustrated in FIG. 5, these values may be quantized at a broader quantization step interval than the high-frequency region.

Furthermore, although the quantization step interval in the high-frequency region is uniform in the example illustrated in FIG. 5, the quantization step interval may be changed according to the frequency. For example, the quantization step interval may be set so that as the frequency increases, the quantization step interval narrows.

Additionally, although the quantization step interval is determined in accordance with the frequency in the example illustrated in FIG. 5, the quantization step interval may be determined using an index based on the frequency. For example, based on a probability distribution p(x) that takes a value (x) of each element in a tensor as a probability variable, the degree of difference of a probability distribution q(x) that takes a value (x) of each element in the quantized tensor as a probability variable may be measured, and the quantization step interval may be determined as a method of quantization that reduces that difference (e.g., a way of determining the quantization step interval).

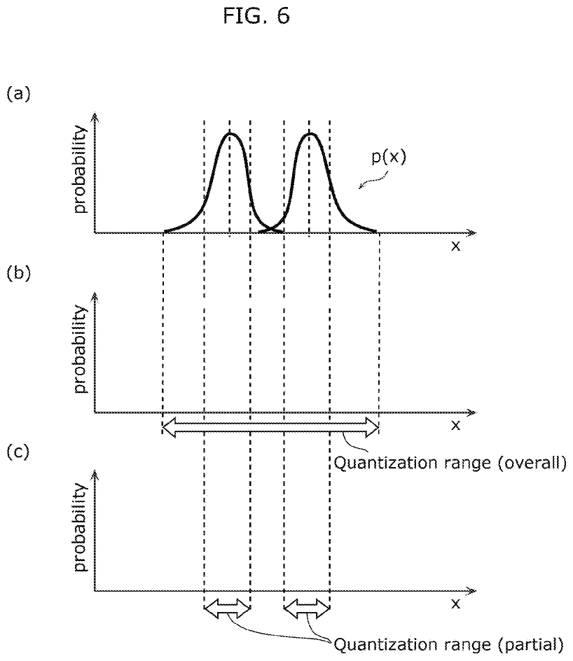

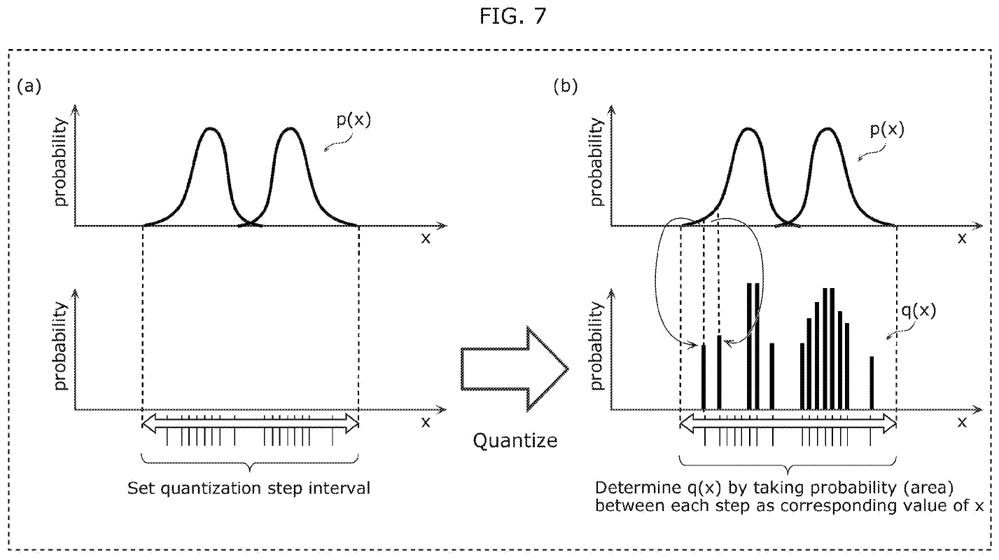

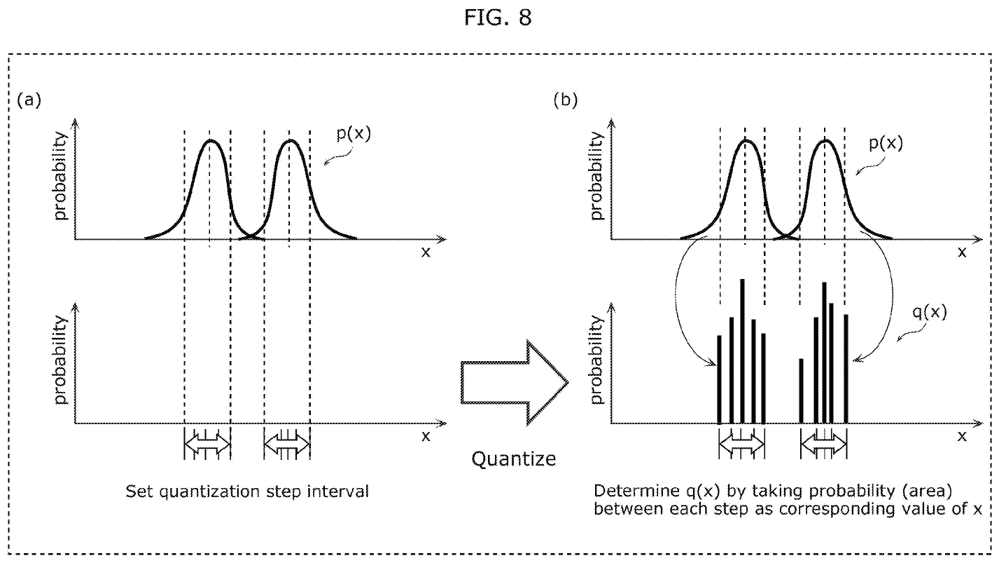

An example of this will be described hereinafter with reference to FIGS. 6 to 8. FIG. 6 is a schematic diagram illustrating a quantization range according to a variation on the present embodiment. FIG. 7 is a schematic diagram illustrating an example of a quantization step interval determination method according to a variation on the present embodiment. FIG. 8 is a schematic diagram illustrating another example of a quantization step interval determination method according to a variation on the present embodiment.

The range of x to be quantized is set first. For example, as indicated in graph (b) in FIG. 6, the entire range of x where data is present is set as the quantization range. Alternatively, as indicated in graph (c) in FIG. 6, a range of some of the x values where data is present is set to the quantization range, e.g., by excluding regions having low frequencies from the range.

The quantization step interval is set next. For example, when the entire range of x where data is present is set as the quantization range (graph (b) in FIG. 6), and when a range of some of the x values where data is present is set to the quantization range (graph (c) in FIG. 6), the quantization step in the quantization range is set as indicated in graph (a) in FIG. 7 and graph (b) in FIG. 8, respectively.

Next, the probability distribution q(x) corresponding to the value of the quantized tensor for the set quantization step is found, as indicated in graph (b) in FIG. 7 and graph (b) in FIG. 8. A plurality of instances of q(x) having different quantization ranges and quantization step intervals such as these are prepared. Next, using the Kullback-Leibler divergence (where the lower the value of this measure, the more similar q(x) is to p(x)) as a measure of the difference between the two probability distributions p(x) and q(x), q(x) for which this measure is lower smaller than a predetermined value is determined. The quantization step interval, which is the setting for this instance of q(x), may be used as the quantization step interval to be found. For example, the quantization step interval that gives q(x) having the minimum Kullback-Leibler divergence may be taken as the quantization step interval to be found. Note that the Kullback-Leibler divergence is expressed by the following Equation (1).

$$[ Equation 1 ]$$

$${D}_{KL} ( p ( x ) \vert \vert q ( x ) ) = - \int p ( x ) log \frac{q ( x )}{p ( x )} dx \qquad ( 1 )$$

### 1-5. Computation Method

Specific examples of computation methods used by parameter generator 20 will be described next. Three computation methods will be described hereinafter as examples of computation methods which can be used in the quantization method according to the present embodiment.

1-5-1. m-Bit Fixed Point

A computation method for quantizing floating point-precision data into m-bit fixed-point data will be described next. When the floating point-precision data is represented by x, using 2⁻ⁿ as a scaling factor, x is converted to an m-bit fixed point-precision value FXP(x,m,n) using the following Equation (2).

$$[ Equation 2 ]$$

$$FXP ( x , m , n ) = Clip ( \vert \frac{x}{{2}^{- n}} + 0.5 \vert \cdot {2}^{- n} , MIN , MAX ) \qquad ( 2 )$$

Here, the function Clip(a,MIN,MAX) is a function which keeps the value of variable a within a range between MIN and MAX, and is defined by the following Equation (3).

$$[ Equation 3 ]$$

$$Clip ( a , MIN , MAX ) = \{ \begin{matrix}MIN & ( a < MIN ) \\ a & ( MIN \leq a \leq MAX ) \\ MAX & ( MAX < a )\end{matrix} \qquad ( 3 )$$

MIN and MAX in Equation (2) above are expressed by the following Equations (4) and (5).

[Equation 4]

MIN=−2^{m-1}·2⁻ⁿ (4)

[Equation 5]

MAX=(2^{m-1}−1)·2⁻ⁿ (5)

When using such a quantization method, a code mode and a decimal point position are used as quantization parameters.

“Code mode” is a parameter that indicates whether or not the global minimum value of FXP(x,m,n) is at least 0. For example, if the global minimum value of FXP(x,m,n) is at least 0, there is no need to assign bits to negative values, which makes it possible to save one bit. “Decimal point position” is a fixed point position capable of expressing a value between MIN and MAX. For example, when the distribution of variable x can be approximated by a normal distribution (a Gaussian distribution), the decimal point position can be determined by obtaining information such as the median value, the standard deviation, and the like in statistical information database 18 mentioned above. Although an example in which the distribution of variable x is approximated by a normal distribution is described here, the distribution of variable x is not limited to a normal distribution. Even when the distribution of variable x is approximated by another distribution, the decimal point position can be determined appropriately in accordance with the shape of the distribution. For example, when the distribution of variable x is approximated by a contaminated normal distribution, the decimal point position may be determined for each of the plurality of peaks in the contaminated normal distribution.

### 1-5-2. Logarithm

A computation method for quantizing floating point-precision data using a logarithm will be described next. In this computation method, the logarithm of the data value is taken and bits are assigned on a logarithmic scale. In this method, a logarithmic maximum is used as the quantization parameter. “Logarithmic maximum” is the global maximum value of the logarithm that does not exceed the global maximum value of the floating point-precision data obtained from statistical information database 18.

### 1-5-3. Ternary and Binary

A computation method for quantizing floating point-precision data into ternary data will be described next. In this computation method, floating point-precision data, which is an example of a tensor value, is quantized into three values, i.e., −1, 0, and +1, based on the statistical information database. In this quantization, four quantization parameters are used, namely a positive threshold, a negative threshold, a positive scale, and a negative scale. The positive threshold is the smallest number that will be quantized to +1, and the negative threshold is the largest number that will be quantized to −1. The positive scale and negative scale are coefficients corresponding to +1 and −1, respectively. To be more specific, the positive scale is a coefficient for approximating the value of floating point data from +1, and the negative scale is a coefficient for approximating the value of floating point data from −1.

For example, the median value, the global minimum value, and the global maximum value of the data distribution are obtained from statistical information database 18, a predetermined range in the positive direction and the negative direction from the median value is determined, and the values of the data in that range are quantized to zero. The thresholds of the range in the positive direction and the negative direction are determined to be the positive threshold and the negative threshold that are the aforementioned quantization parameters. Furthermore, assuming that the absolute values of the global maximum value and the global minimum value are floating point approximations of +1 and −1, respectively, the absolute values of the global maximum value and the global minimum value are determined to be the positive scale and the negative scale, respectively, which are the aforementioned quantization parameters.

According to this quantization method, for example, in a sum-of-products operation in a convolutional neural network, the multiplication of weights and data values can be implemented by multiplying the weights by +1, 0, or −1. In other words, because multiplication is substantially unnecessary in a sum-of-products operation, the amount of computations can be greatly reduced.

Additionally, in this computation method, floating point-precision data, which is an example of a tensor value, may be quantized into two values, i.e., −1 and +1, based on the statistical information database. Binary quantization can be regarded as the integration of the value −1 and the value 0 in the ternary quantization into a single value −1, and a single threshold having the same value for the positive threshold and the negative threshold is used. The positive scale and the negative scale are the same for binary quantization as for ternary quantization.

### Embodiment 2

A network quantization method according to Embodiment 2 will be described. The network quantization method according to the present embodiment differs from the quantization method of Embodiment 1 in that the test datasets are classified into a plurality of types based on the statistical information of the test datasets, and different processing is performed for each type. A network quantization method, a network quantization apparatus and an inference method using a quantized network generated by the network quantization method according to the present embodiment will be described next, focusing on the points which are different from Embodiment 1.

### 2-1. Network Quantization Apparatus

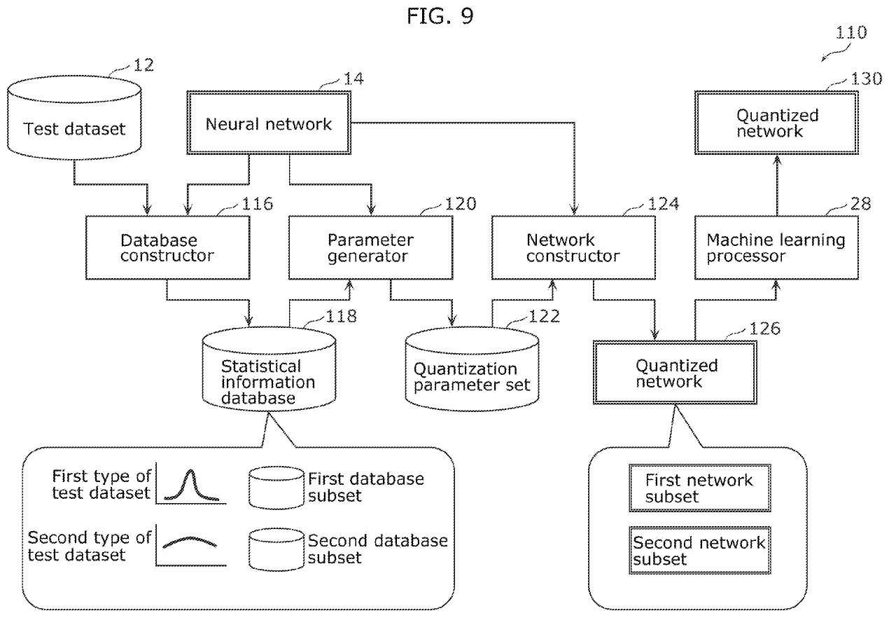

The configuration of the network quantization apparatus according to the present embodiment will be described first with reference to FIG. 9. FIG. 9 is a block diagram illustrating an overview of the functional configuration of network quantization apparatus 110 according to the present embodiment.

As illustrated in FIG. 9, network quantization apparatus 110 includes database constructor 116, parameter generator 120, and network constructor 124. In the present embodiment, network quantization apparatus 110 further includes machine learning processor 28. Network quantization apparatus 110 according to the present embodiment differs from network quantization apparatus 10 according to Embodiment 1 in terms of database constructor 116, parameter generator 120, and network constructor 124.

As described in Embodiment 1, a quantization network having better accuracy can be obtained by changing the quantization step interval for each region of tensor values in accordance with the distribution of the tensor values handled by neural network 14. Accordingly, in the present embodiment, a quantized network having even better accuracy is obtained by performing the quantization for each type of the plurality of test datasets 12.

Like the database constructor according to Embodiment 1, database constructor 116 according to the present embodiment constructs a statistical information database of the tensors handled by neural network 14 obtained when a plurality of test datasets are input to neural network 14. In the present embodiment, database constructor 116 classifies at least some of the plurality of test datasets 12 into a first type and a second type based on each instance of statistical information in the plurality of test datasets 12. For example, when a plurality of images are used as the plurality of test datasets 12, the plurality of images are classified, based on the statistical information such as the brightness of the images, into a type classified as daytime outdoor images, a type classified as nighttime outdoor images, and so on. As a specific computation method, for example, the distribution of the tensors for all of the plurality of test datasets 12 may be assumed to conform to a contaminated normal distribution, and each of the plurality of normal distributions included in the mixed normal distribution may be classified as a single type. In this case, each of the test datasets may be classified by verifying each of the plurality of test datasets 12 against the plurality of normal distributions.

Statistical information database 118 constructed by database constructor 116 includes a first database subset and a second database subset, which correspond to the first type and the second type, respectively. In other words, database constructor 116 constructs the first database subset including statistical information of the tensors handled by neural network 14 obtained when test datasets, among the plurality of test datasets 12, which are included in the first type are input to neural network 14. Additionally, database constructor 116 constructs the second database subset including statistical information of the tensors handled by neural network 14 obtained when test datasets, among the plurality of test datasets 12, which are included in the second type are input to neural network 14.

Like parameter generator 20 according to Embodiment 1, parameter generator 120 generates quantization parameter set 122 by quantizing the tensor values based on the statistical information database and the neural network. In the present embodiment, quantization parameter set 122 includes a first parameter subset and a second parameter subset, which correspond to the first database subset and the second database subset, respectively.

Like network constructor 24 according to Embodiment 1, network constructor 124 constructs quantized network 126 by quantizing the neural network using quantization parameter set 122. In the present embodiment, quantized network 126 includes a first network subset and a second network subset, which correspond to the first parameter subset and the second parameter subset, respectively.

Accordingly, in the present embodiment, a quantized network corresponding to each of the first type and the second type of the plurality of test datasets 12 is constructed, and thus a quantized network having better accuracy can be constructed.

Like Embodiment 1, in the present embodiment, machine learning processor 28 causes quantized network 126 to perform machine learning. In the present embodiment, machine learning processor 28 causes the machine learning to be performed by inputting the first type and second type of test datasets into the first network subset and the second network subset, respectively. Through this, quantized network 130, which has a better accuracy than quantized network 126, can be constructed.

Database constructor 116 classifies the plurality of test datasets 12 into at least three types. Accordingly, statistical information database 118 may include at least three database subsets, and quantization parameter set 122 may include three or more parameter subsets. Quantized network 126 and quantized network 130 may each include at least three network subsets.

### 2-2. Network Quantization Method and Inference Method

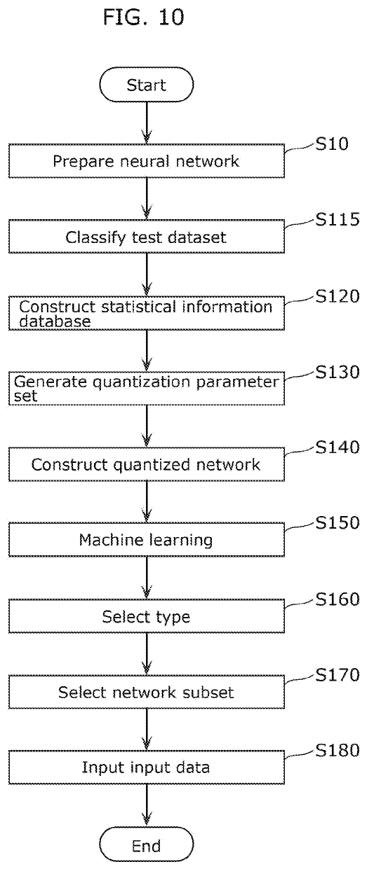

A network quantization method and an inference method according to the present embodiment will be described next with reference to FIG. 10. FIG. 10 is a flowchart illustrating a network quantization method and an inference method according to the present embodiment.

The inference method according to the present embodiment includes all the steps in the flowchart illustrated in FIG. 10, whereas the network quantization method according to the present embodiment includes steps S10 to S150 in the flowchart illustrated in FIG. 10.

As illustrated in FIG. 10, in the network quantization method and the inference method according to the present embodiment, first, neural network 14 is prepared, in the same manner as in the network quantization method according to Embodiment 1 (S10).

Next, database constructor 116 classifies at least some of the plurality of test datasets 12 into the first type and the second type based on each instance of statistical information in the plurality of test datasets 12 (S115).

Next, database constructor 116 constructs statistical information database 118 of the tensors handled by neural network 14 obtained when a plurality of test datasets 12 are input to neural network 14 (S120). In the present embodiment, statistical information database 118 includes a first database subset and a second database subset, which correspond to the first type and the second type, respectively.

Next, parameter generator 120 generates quantization parameter set 122 by quantizing the tensor values based on statistical information database 118 and neural network 14 (S130). In the present embodiment, quantization parameter set 122 includes a first parameter subset and a second parameter subset, which correspond to the first database subset and the second database subset, respectively.

Next, network constructor 124 constructs quantized network 126 by quantizing neural network 14 using quantization parameter set 122 (S140). In the present embodiment, quantized network 126 includes a first network subset and a second network subset constructed by quantizing neural network 14 using the first parameter subset and the second parameter subset, respectively.

Next, machine learning processor 28 causes quantized network 126 to perform machine learning (S150). Machine learning processor 28 causes the machine learning to be performed by inputting the plurality of test datasets 12 or other input datasets into quantized network 126 constructed by network constructor 124. In the present embodiment, machine learning processor 28 causes the machine learning to be performed by inputting the first type and second type of test datasets into the first network subset and the second network subset, respectively. Through this, quantized network 130, which has a better accuracy than quantized network 126, can be constructed. Note that the network quantization method according to the present embodiment does not absolutely have to include machine learning step S150.

As described above, with the network quantization method according to the present embodiment, a neural network can be quantized accurately.

Next, in the inference method according to the present embodiment, inference is executed using quantized network 126 constructed through the above-described network quantization method. Specifically, first, input data is prepared, and of the first type and the second type, the type into which the input data to be input to quantized network 126 is classified is selected (S160). This step S160 may be performed, for example, by a computer, in which quantized network 126 is implemented, analyzing the input data and selecting a type based on the statistical information of the input data.

Next, one of the first network subset and the second network subset is selected based on the type, of the first type and the second type, selected in the type selection step S160 (S170). This step S160 may be performed, for example, by a computer, in which quantized network 126 is implemented, selecting the network subset corresponding to the selected type.

Next, the input data is input to the one of the first network subset and the second network subset selected in the network selection step S170 (S180). As a result, inference is executed using the selected network subset.

With the inference method according to the present embodiment, the inference is executed using a quantized network which has been quantized with good accuracy as described above, and thus an inference result having good accuracy is obtained. Furthermore, according to the present embodiment, the inference is executed using a quantized network suited to the type of the input data, and thus an inference result having even better accuracy is obtained.

### Variations, etc.

Although a network quantization method and the like according to the present disclosure have been described thus far based on embodiments, the network quantization method and the like are not limited to these embodiments. Variations on the embodiments conceived by one skilled in the art, other embodiments implemented by combining constituent elements from the embodiments, and the like, for as long as they do not depart from the essential spirit thereof, fall within the scope of the present disclosure.

For example, the parameter generation step in the network quantization method according to a variation on the above-described Embodiment 1 may, based on the statistical information database, determine a quantization region of tensor values which do not have a frequency of zero and a non-quantization region of tensor values which do not have a frequency of zero and which does not overlap with the quantization region, with tensor values in the quantization region being quantized and tensor values in the non-quantization region not being quantized. Additionally, a parameter generator included in a network quantization apparatus according to a variation on the above-described Embodiment 1 may, based on the statistical information database, determine a quantization region of tensor values which do not have a frequency of zero and a non-quantization region of tensor values which do not have a frequency of zero and which does not overlap with the quantization region, with tensor values in the quantization region being quantized and tensor values in the non-quantization region not being quantized.

The present variation corresponds, for example, to a case where, in the network quantization method and the network quantization apparatus according to the above-described Embodiment 1, at least part of the first region and the second region are determined as the quantization region, at least part of the third region to the fifth region is determined as the non-quantization region, and the tensor values in the non-quantization region are not quantized.

In this manner, by selecting tensor values for which the frequency of the tensor values to be quantized is not zero, the accuracy of the quantization can be improved compared to a case where the tensor values to be quantized include values with a frequency of zero. This makes it possible to construct a quantized network having good accuracy.

Additionally, in the present variation, the quantization region may include the tensor values which have a maximum frequency, and the non-quantization region may include the tensor values which have a lower frequency than those of the quantization region.

The present variation corresponds, for example, to a case where, in the network quantization method and the network quantization apparatus according to the above-described Embodiment 1, at least one of the first region and the second region are determined as the quantization region, at least part of the third region to the fifth region is determined as the non-quantization region, and the tensor values in the non-quantization region are not quantized.

In this manner, the quantization region includes tensor values which have a maximum frequency, and thus the accuracy of the quantization can be improved even further. This makes it possible to construct a quantized network having even better accuracy.

Additionally, the parameter generation step of the network quantization method according to the present variation may determine the quantization region and the non-quantization region using an index based on the frequency. For example, the parameter generation step may determine the quantization region and the non-quantization region in accordance with a measure of a difference between a distribution of tensor values and a distribution of quantized tensor values. Additionally, the parameter generator of the network quantization apparatus may determine the quantization region and the non-quantization region in accordance with a measure of a difference between a distribution of tensor values and a distribution of quantized tensor values. The Kullback-Leibler divergence may be used as such a measure, for example.

The embodiments described below may also be included within the scope of one or more aspects of the present disclosure.

(1) Some of the constituent elements constituting the network quantization apparatus may be a computer system constituted by a microprocessor, ROM, RAM, a hard disk unit, a display unit, a keyboard, a mouse, and the like. A computer program is stored in the RAM or hard disk unit. The microprocessor realizes the functions thereof by operating in accordance with the computer program. Here, the computer program is constituted by a combination of a plurality of command codes that indicate commands made to a computer to achieve a predetermined function.

(2) Some of the constituent elements of the above-described network quantization apparatus may be constituted by a single system LSI (Large Scale Integration) circuit. “System LSI” refers to very-large-scale integration in which multiple constituent elements are integrated on a single chip, and specifically, refers to a computer system configured including a microprocessor, ROM, RAM, and the like. A computer program is stored in the RAM. The system LSI circuit realizes the functions thereof by the microprocessor operating in accordance with the computer program.

(3) Some of the constituent elements constituting the above-described network quantization apparatus may be constituted by IC cards or stand-alone modules that can be removed from and mounted in the apparatus. The IC card or module is a computer system constituted by a microprocessor, ROM, RAM, and the like. The IC card or module may include the above very-large-scale integration LSI circuit. The IC card or module realizes the functions thereof by the microprocessor operating in accordance with the computer program. The IC card or module may be tamper-resistant.

(4) Some of the constituent elements of the above-described network quantization apparatus may also be computer programs or digital signals recorded in a computer-readable recording medium such as a flexible disk, hard disk, CD-ROM, MO, DVD, DVD-ROM, DVD-RAM, BD (Blu-ray (registered trademark) Disc), semiconductor memory, or the like. The constituent elements may also be the digital signals recorded in such a recording medium.

Some of the constituent elements of the above-described network quantization apparatus may be realized by transmitting the computer program or digital signal via a telecommunication line, a wireless or wired communication line, a network such as the Internet, a data broadcast, or the like.

(5) The present disclosure may be realized by the methods described above. This may be a computer program that implements these methods on a computer, or a digital signal constituting the computer program.

(6) The present disclosure may also be a computer system including a microprocessor and memory, where the memory stores the above-described computer program and the microprocessor operates in accordance with the computer program.

(7) The present disclosure may also be implemented by another independent computer system, by recording the program or the digital signal in the recording medium and transferring the recording medium, or by transferring the program or the digital signal over the network or the like.

(8) The above-described embodiments and variations may be combined as well.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The present disclosure is useful in image processing methods and the like, as a method for implementing a neural network in a computer or the like.

1. A network quantization method of quantizing a neural network, the network quantization method comprising:
preparing the neural network;
constructing a statistical information database of tensors handled by the neural network, the tensors obtained when a plurality of test datasets are input to the neural network;
generating a quantization parameter set by quantizing values of the tensors based on the statistical information database and the neural network; and
constructing a quantized network by quantizing the neural network using the quantization parameter set,
wherein in the generating, based on the statistical information database, a quantization step interval in a high-frequency region is set to be narrower than a quantization step interval in a low-frequency region, the high-frequency region including a value, among the values of the tensors, having a frequency that is a local maximum, and the low-frequency region including a value of the tensors that has a lower frequency than in the high-frequency region.

2. A network quantization method of quantizing a neural network, the network quantization method comprising:
preparing the neural network;
constructing a statistical information database of tensors handled by the neural network, the tensors obtained when a plurality of test datasets are input to the neural network;
generating a quantization parameter set by quantizing values of the tensors based on the statistical information database and the neural network; and
constructing a quantized network by quantizing the neural network using the quantization parameter set,
wherein in the generating, a quantization region and a non-quantization region which does not overlap with the quantization region are determined based on the statistical information database, and values of the tensors in the quantization region are quantized while values of the tensors in the non-quantization region are not quantized.

3. A network quantization method of quantizing a neural network, the network quantization method comprising:
preparing the neural network;
constructing a statistical information database of tensors handled by the neural network, the tensors obtained when a plurality of test datasets are input to the neural network;
generating a quantization parameter set by quantizing values of the tensors based on the statistical information database and the neural network; and
constructing a quantized network by quantizing the neural network using the quantization parameter set,
wherein in the generating, the values of the tensors are ternarized based on the statistical information database.

4. A network quantization method of quantizing a neural network, the network quantization method comprising:
preparing the neural network;
constructing a statistical information database of tensors handled by the neural network, the tensors obtained when a plurality of test datasets are input to the neural network;
generating a quantization parameter set by quantizing values of the tensors based on the statistical information database and the neural network; and
constructing a quantized network by quantizing the neural network using the quantization parameter set,
wherein in the generating, the values of the tensors are binarized based on the statistical information database.

5. The network quantization method according to claim 3,
wherein in the generating, the values of the tensors are quantized to three values of −1, 0, and +1 in the ternarizing of the values of the sensors.

6. The network quantization method according to claim 5,
wherein in the generating, a positive threshold and a negative threshold are determined as quantization parameters based on the statistical information database, the positive threshold being a lowest number quantized to +1 and the negative threshold being a highest number quantized to −1.

7. The network quantization method according to claim 4,
wherein in the generating, the values of the tensors are quantized to two values of −1 and +1 in the binarizing of the values of the sensors.

8. The network quantization method according to claim 7,
wherein in the generating, a positive threshold and a negative threshold are determined as quantization parameters based on the statistical information database, the positive threshold being a lowest number quantized to +1 and the negative threshold being a highest number quantized to −1.

9. The network quantization method according to claim 6,
wherein in the generating, a positive scale and a negative scale are determined as quantization parameters based on the statistical information database, the positive scale and the negative scale being coefficients corresponding to +1 and −1, respectively.

10. The network quantization method according to claim 8,
wherein in the generating, a positive scale and a negative scale are determined as quantization parameters based on the statistical information database, the positive scale and the negative scale being coefficients corresponding to +1 and −1, respectively.

11. The network quantization method according to claim 2,
wherein the quantization region includes, among the values of the tensors, a value having a frequency that is a local maximum, and the non-quantization region includes, among the values of the tensors, a value having a lower frequency than the value in the quantization region.

12. The network quantization method according to claim 1,
wherein the high-frequency region includes a first region and a second region each including a value, among the values of the tensors, having a frequency that is a local maximum, and
the low-frequency region includes a third region including a value, among the values of the tensors, that is between the values in the first region and the second region.

13. The network quantization method according to claim 1,
wherein in the generating, the values of the tensors in at least part of the low-frequency region are not quantized.

14. The network quantization method according to claim 12,
wherein in the generating, the values of the tensors in at least part of the low-frequency region are not quantized.

15. The network quantization method according to claim 1, further comprising:
causing the quantized network to perform machine learning.

16. The network quantization method according to claim 2, further comprising:
causing the quantized network to perform machine learning.

17. The network quantization method according to claim 3, further comprising:
causing the quantized network to perform machine learning.

18. The network quantization method according to claim 4, further comprising:
causing the quantized network to perform machine learning.

19. The network quantization method according to claim 1, further comprising:
classifying at least some of the plurality of test datasets into a first type and a second type based on respective instances of statistical information in the plurality of test datasets,
wherein the statistical information database includes a first database subset and a second database subset corresponding to the first type and the second type, respectively,
the quantization parameter set includes a first parameter subset and a second parameter subset corresponding to the first database subset and the second database subset, respectively, and
the quantized network includes a first network subset and a second network subset constructed by quantizing the neural network using the first parameter subset and the second parameter subset, respectively.

20. The network quantization method according to claim 2, further comprising:
classifying at least some of the plurality of test datasets into a first type and a second type based on respective instances of statistical information in the plurality of test datasets,
wherein the statistical information database includes a first database subset and a second database subset corresponding to the first type and the second type, respectively,
the quantization parameter set includes a first parameter subset and a second parameter subset corresponding to the first database subset and the second database subset, respectively, and
the quantized network includes a first network subset and a second network subset constructed by quantizing the neural network using the first parameter subset and the second parameter subset, respectively.

21. The network quantization method according to claim 3, further comprising:
classifying at least some of the plurality of test datasets into a first type and a second type based on respective instances of statistical information in the plurality of test datasets,
wherein the statistical information database includes a first database subset and a second database subset corresponding to the first type and the second type, respectively,
the quantization parameter set includes a first parameter subset and a second parameter subset corresponding to the first database subset and the second database subset, respectively, and
the quantized network includes a first network subset and a second network subset constructed by quantizing the neural network using the first parameter subset and the second parameter subset, respectively.

22. The network quantization method according to claim 4, further comprising:
classifying at least some of the plurality of test datasets into a first type and a second type based on respective instances of statistical information in the plurality of test datasets,
wherein the statistical information database includes a first database subset and a second database subset corresponding to the first type and the second type, respectively,
the quantization parameter set includes a first parameter subset and a second parameter subset corresponding to the first database subset and the second database subset, respectively, and
the quantized network includes a first network subset and a second network subset constructed by quantizing the neural network using the first parameter subset and the second parameter subset, respectively.

23. The network quantization method according to claim 1,
wherein the frequency of the low-frequency region is not zero.

24. The network quantization method according to claim 2,
wherein the frequency of the non-quantization region is not zero.

25. An inference method, comprising:
the network quantization method according to claim 19;
selecting, from the first type and the second type, a type into which input data input to the quantized network is to be classified;
selecting one of the first network subset and the second network subset based on the type, of the first type and the second type, selected in the selecting of the type; and
inputting the input data into the one of the first network subset and the second network subset selected in the selecting of the one of the first network subset and the second network subset.

26. An inference method, comprising:
the network quantization method according to claim 20;
selecting, from the first type and the second type, a type into which input data input to the quantized network is to be classified;
selecting one of the first network subset and the second network subset based on the type, of the first type and the second type, selected in the selecting of the type; and
inputting the input data into the one of the first network subset and the second network subset selected in the selecting of the one of the first network subset and the second network subset.

27. An inference method, comprising:
the network quantization method according to claim 21;
selecting, from the first type and the second type, a type into which input data input to the quantized network is to be classified;
selecting one of the first network subset and the second network subset based on the type, of the first type and the second type, selected in the selecting of the type; and
inputting the input data into the one of the first network subset and the second network subset selected in the selecting of the one of the first network subset and the second network subset.

28. An inference method, comprising:
the network quantization method according to claim 22;
selecting, from the first type and the second type, a type into which input data input to the quantized network is to be classified;
selecting one of the first network subset and the second network subset based on the type, of the first type and the second type, selected in the selecting of the type; and
inputting the input data into the one of the first network subset and the second network subset selected in the selecting of the one of the first network subset and the second network subset.
